(19) United States
(12) Patent Application Publication
(10) Pub. No.: US 2009/0067474 A1
(43) Pub. Date: Mar. 12, 2009

(54) Adjusting method and system thereof for a temperature sensing element

(76) Inventors: Chao-Chi Lee, Hsinchu (TW); Yeow-Chin Chen, Hsinchu (TW)

Correspondence Address: Mr. Robert Berliner;BERLINER & ASSOCIATES, 31st Floor, 555 West Fifth Street, Los Angeles, CA, 90013, US

(21) Appl. No.: 12/220,270

(22) Filed: Jul. 23, 2008

(30) Foreign Application Priority Data
Sep. 12, 2007 (TW) 096133987

(51) Int. Cl. G01K 7/16

(52) U.S. Cl. 374/185; 374/E07.018

(57) ABSTRACT

A method and a system thereof for adjusting a temperature sensing element are proposed. The temperature sensing element is coupled to a control chip and has a temperature sensing resistor. Firstly, a memory area of the control chip is set to pre-store a temperature standard, and a predetermined standard is defined such that the temperature standard is equal to the predetermined standard ±ΔT. Then, the temperature sensing element is placed in and thermal equilibrates with a constant-temperature environment. The temperature sensing resistor is oscillated until a temperature measured by the temperature sensing element is consistent with the predetermined standard such that a first oscillation time is determined. A reference resistor is provided and oscillated based on the first oscillation time to determine an updated temperature standard, and then the updated temperature standard is stored to the memory area to replace the temperature standard pre-stored in the memory area.

### FIELD OF THE INVENTION

The present invention relates to an adjusting method and an adjusting system thereof, and more particularly, to an adjusting method and an adjusting system thereof for adjusting a temperature sensing element.

### BACKGROUND OF THE INVENTION

The modern electronic clinical thermometers usually use thermally sensitive resistors as elements for sensing body temperature. In other words, because of the characteristic a thermally sensitive resistor Rs that its resistance varies with the temperature (for example, when the temperature rises, the resistance of a thermally sensitive resistor having a negative resistance temperature coefficient decreases), a corresponding value of the temperature of a detected object can be measured. The method for measuring the temperature of the object is providing an oscillation circuit that has a thermally sensitive resistor can be oscillated. Because the oscillation frequency varies with the resistance of the thermally sensitive resistor, by detecting the number ck of clocks of the oscillation signal within a predetermined oscillation period and converting/counting the number via a nonlinear converting circuit and a counter, the temperature, which represents the corresponding measured counting value, could be detected.

Please refer to table 1, the type 503ET is taken for example (the resistance is assumed to be 30 KΩ when the temperature is 37° C.). A reference resistor Ref having a resistance of 30 KΩ is installed in the oscillation circuit. The reference resistor Ref is controlled to oscillating to generate an oscillating signal having clocks of a number ck, then stop oscillating the reference resistor Ref when the temperature, which is detected behind the converting/counting, is equal to 37° C. The oscillating time T of the reference resistor Ref is recorded. Then, the thermally sensitive resistor Rs generates clocks of the number ck according to the oscillating time T, and the present temperature is displayed by converting/counting the number ck.

TABLE 1
the characteristics of common used thermally sensitive resistors

| | |
|---|---|
| Temperature | Type (KΩ) |

| (° C.) | 503ET | 833ET | 224ET | 234ET |
|---|---|---|---|---|
| R30 | 40.22 | 67.04 | 182.4 | 184.5 |
| R37 | 30.00 | 50.00 | 136.0 | 135.0 |
| R45 | 21.75 | 36.25 | 98.56 | 95.87 |
| B30/45 (K) | 3953 | 3953 | 3958 | 4209 |

According to the above table, the value of the reference resistor Ref should be consistent with the value of the thermally sensitive resistor Rs in the condition having the same temperature. Otherwise, a deviation between the measured temperature and the actual temperature will be generated. That is, the measured temperature is deviated higher when the number ck of the oscillating clocks increases with a lower resistance, and the measured temperature is deviated lower when the number ck of the oscillating clocks decreases with a higher resistance. Therefore, repeatedly taking the type 503ET of the temperature is 37° C. for example, if the measured resistance of the thermally sensitive resistor Rs is merely equal to 29 KΩ, which is lower than the standard 30 KΩ, because the number ck of the oscillating clocks increases correspondingly, the measured temperature is thus higher than the actual temperature 37° C. Therefore, a deviation of temperature is occurred.

In order to overcome the above mentioned drawback, the system manufacturer usually adjusts his products leaving the factory such that the inaccuracy of the electronic clinical thermometer falls within a predetermined range. As shown in FIG. 1, which is a flow chart of a normal adjusting procedure for an electronic thermometer. Firstly, every thermally sensitive resistor is measured and classified respectively. Then, a corresponding resistor is selected to connect in parallel or in series with the reference resistor, and the resistors of the thermometer is tested in a thermostatic trough. If the measured result falls beyond the specification, the resistor should be modified and compensated until the specification is satisfied.

However, based on the above mentioned adjusting method, it is necessary to connect a compensation resistor in parallel or in series such that the labor power, material resources and the cost of time are increased correspondingly.

### SUMMARY OF THE INVENTION

The problem to be solved here, therefore, an objective of the present invention is to provide an adjusting method and an adjusting system thereof for adjusting a temperature sensing element while easily adjusting the inaccuracy of the temperature standard.

Another objective of the present invention is to provide an adjusting method and an adjusting system thereof for adjusting a temperature sensing element such that unnecessary cost, which is resulted from the usage different compensation resistors, could be avoided.

In accordance with the above and other objectives, the present invention proposes a method for adjusting a temperature sensing element. The temperature sensing element is coupled to a control chip and has a temperature sensing resistor. The method comprising following steps: setting a memory area of the control chip, wherein the memory area pre-stores a temperature standard, and then defining a predetermined standard and setting the temperature standard to be equal to the predetermined standard ±ΔT; providing an constant-temperature environment, and then placing the temperature sensing element in the constant-temperature environment and thermal equilibrating the temperature sensing element with the constant-temperature environment; oscillating the temperature sensing resistor until a temperature measured by the temperature sensing element is consistent with the predetermined standard so as to determine a first oscillation time; and providing a reference resistor, and oscillating the reference resistor according to the first oscillation time to determine an updated temperature standard, and then storing the updated temperature standard to the memory area to replace the temperature standard pre-stored in the memory area.

The above method of the present invention further comprises: commanding the control chip to read the updated temperature standard, and then oscillating the reference resistor until a temperature measured by the temperature sensing element is consistent with the updated temperature standard so as to determine a second oscillation time; and oscillating the temperature sensing resistor according to the second oscillation time, and then displaying a measured temperature after calculating and converting.

In accordance with the same objectives, the present invention proposes an adjusting system for adjusting a temperature sensing element. The temperature sensing element has a temperature sensing resistor and is coupled to a control chip and placed in a constant-temperature environment. The adjusting system at least comprises a memory unit for setting a memory area, wherein the memory area pre-stores a temperature standard and defines a predetermined standard, the temperature standard is set to be equal to the predetermined standard ±ΔT; a signal generating unit for providing a reference resistor and respectively generating oscillation signals of the reference resistor and the temperature sensing resistor; a nonlinear conversion circuit electrically connected to the signal generating unit and used for converting the oscillation signals to pulse signals; a counting unit electrically connected to the nonlinear conversion circuit and used for determining a counting number of pulses according to the pulse signals and determining an oscillation time according to the counting number of pulses; and a control unit electrically connected to the signal generating unit, the counting unit and the memory unit, the control unit being used for oscillating the temperature sensing resistor until a temperature measured by the temperature sensing element is consistent with the predetermined standard such that the counting unit determines a first oscillation time, and the control unit being used for oscillating the reference resistor according to the first oscillation time to determine an updated temperature standard and for storing the updated temperature standard to the memory area to replace the temperature standard pre-stored in the memory area.

The constant-temperature environment of the temperature sensing element provides enough capacity to contain the temperature sensing element for the measuring purpose, and except the limitation in capacity, there is no other specific limitation for the temperature sensing element. For example, the constant-temperature environment could be a thermostatic trough. The control unit of the temperature sensing element could be electrically connected to the control chip. The adjusting system could further comprise a display unit, which displays a measured temperature value of the temperature sensing resistor according to the counting number of pulses.

Moreover, the method of the present invention could further comprises a procedure for detecting an unusual situation of the environment such that the adjusting of the temperature sensing element could be terminated when the unusual situation of the environment occurs. Furthermore, the method could further comprise the step to display an error message when an adjustment range of the updated temperature standard exceeds predetermined upper and lower bounds.

Therefore, in contrast with the prior art, the present invention proposes an adjusting method and an adjusting system thereof to adjust a temperature sensing element such that it is unnecessary for the system manufacturer to connect any compensation resistor in parallel or in series with the reference resistor. Therefore, the purpose to automatically adjust the temperature sensing element could be achieved, and the labor power and cost of time could be reduced.

### BRIEF DESCRIPTION OF THE DRAWINGS

The present invention can be more fully understood by reading the following detailed description of the preferred embodiments, with reference made to the accompanying drawings, wherein:

FIG. 1 is a flow chart showing procedures for adjusting a temperature sensing element according to the prior art;

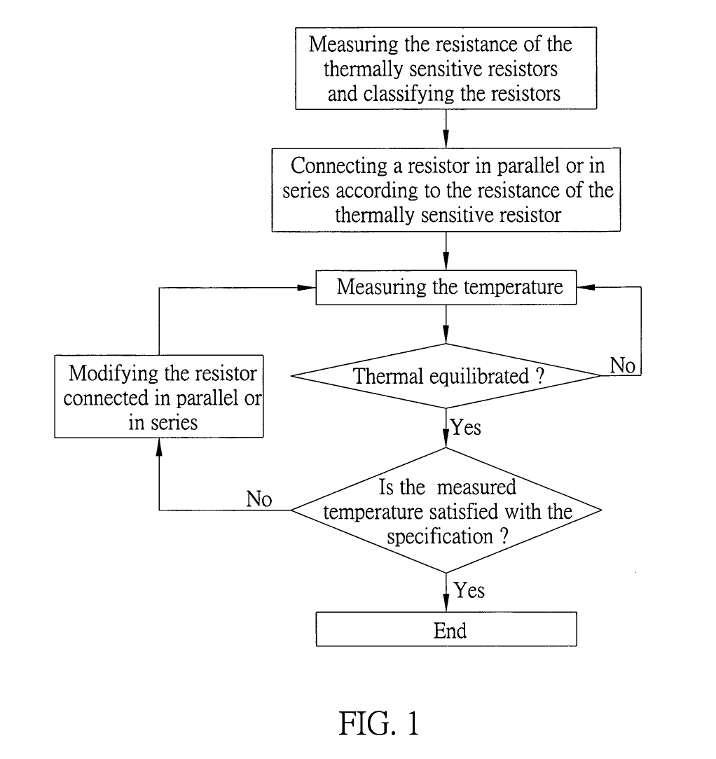

FIG. 2 is a block diagram showing an adjusting system of a temperature sensing element of the present invention; and

FIG. 3 is a flow chart showing procedures for adjusting a temperature sensing element according to the present invention.

### DETAILED DESCRIPTION OF THE EMBODIMENTS

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

The present invention relates to an adjusting method and an adjusting system thereof for adjusting a temperature sensing element, which is coupled to a control chip.

The following embodiment only serves to provide further description for the present invention and is not intended to limit the scope of the invention.

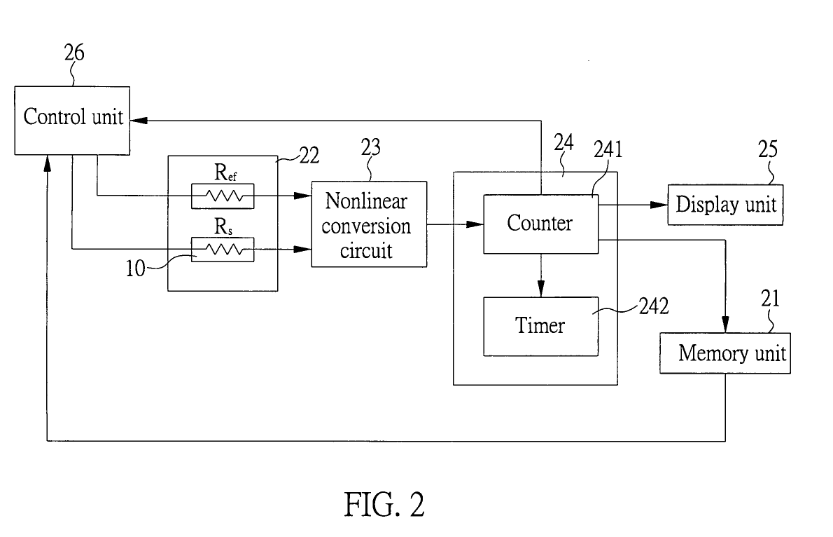

Please refer to FIG. 2, which is a block diagram showing an adjusting system 20 of a temperature sensing element 10 of the present invention. As shown in FIG. 2, the adjusting system 20 has a memory unit 21, a signal generating unit 22, a nonlinear conversion circuit 23, a counting unit 24, a display unit 25, and a control unit 26. The nonlinear conversion circuit 23 is electrically connected to the signal generating unit 22, and the counting unit 24 is electrically connected to the nonlinear conversion circuit 23. The control unit 26 is electrically connected to the signal generating unit 22, the counting unit 24, and the memory unit 21. The display unit 25 is electrically connected to the counting unit 24. Moreover, the adjusting system 20 could be electrically connected to a control chip (not shown) or directly integrated in the control chip. The temperature sensing element 10 is coupled to the control chip and could be a thermally sensitive resistor, a thermocouple or other analog thermometers. The temperature sensing element 10 is suitable for the electronic thermometers for measuring the temperature of the armpit, mouth, anus or ear of a person and suitable for other temperature sensing devices.

The memory unit 21 is used to record and store a temperature standard. The temperature standard is defined as: a predetermined standard ±ΔT, where ΔT is a temperature offset corresponded to a resistance variation within an oscillation time T. The variation of the resistance may cause the difference of the measured temperature. Take the thermally sensitive resistor 833ET/37° C. for example, the predetermined standard is 37° C. when the resistance R37 of the thermally sensitive resistor is equal to 50 KΩ. Therefore, on one hand, if the actual resistance of the thermally sensitive resistor is equal to 49 KΩ, the corresponding measured value of the temperature is higher than the actual temperature (assumed be 37.5° C.). The reason results in the temperature offset corresponded to the resistance variation is that the number ck of clocks of the oscillation signal increases. Therefore, when ΔT decreases to be equal to −0.5° C., the temperature standard is adjusted to be 36.5° C. and the temperature offset of the resistance variation is compensated. On the other hand, if the actual resistance of the thermally sensitive resistor is equal to 51 KΩ, the corresponding measured value of the temperature is higher than the actual temperature (assumed be 36.5° C.). The reason results in the temperature offset corresponded to the resistance variation is that the number ck of clocks of the oscillation signal decreases. Therefore, when ΔT increases to be equal to 0.5° C., the temperature standard is adjusted to be 37.5° C. and the temperature offset of the resistance variation is compensated. It should be noted that the unit of the temperature defined by the memory unit 21 is not limited to be centigrade (° C.). In other words, the unit of the temperature could be Fahrenheit (° F.) or absolute temperature (K).

The signal generating unit 22 is an oscillation circuit. The input port of the oscillation circuit at least comprises a reference resistor Ref and a thermally sensitive resistor Rs. The reference resistor Ref is oscillated to generate an oscillation signal, and the thermally sensitive resistor Rs is oscillated to generate another oscillation signal.

The nonlinear conversion circuit 23 is used to correspondingly convert the oscillation signals to a continuous pulse signal within an oscillation period.

The counting unit 24 primarily comprises a counter 241 and a timer 242. The counter 241 converts the oscillation signals of the reference resistor Ref and the thermally sensitive resistor Rs to the pulse signal via the nonlinear conversion circuit 23 such that pulses of the number ck are generated correspondingly within the oscillation time T. Therefore, the display unit 25 displays the corresponded measure temperature according to the number ck of the pulses. The timer 242 is used to re-calculate the oscillation time T of the reference resistor Ref and the thermally sensitive resistor Rs according to lasted read temperature standard.

The control unit 26 is used to control the thermally sensitive resistor to oscillate until the measured temperature of the temperature sensing element is consistent with the predetermined standard. Then, the counting unit 24 correspondingly generates a first oscillation time T1 such that the reference resistor Ref is oscillated based on the first oscillation time T1 to generate an updated temperature standard. The updated temperature standard is stored to the memory unit 21 to replace the temperature standard pre-stored in the memory unit 21.

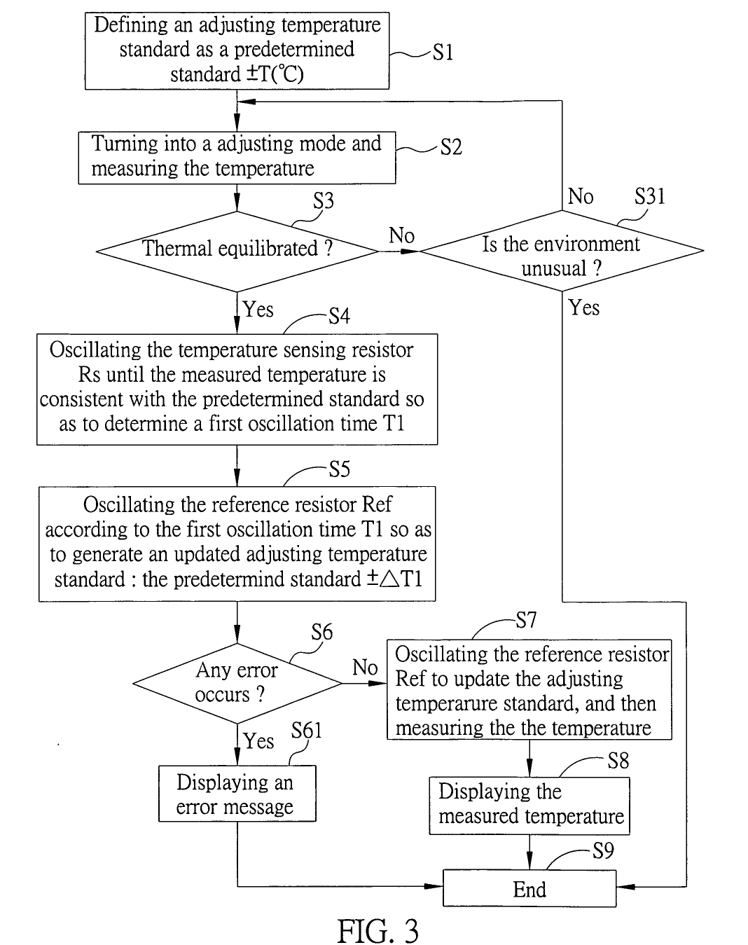

Please refer to FIG. 3, which is a flow chart showing procedures for adjusting the temperature sensing element 10 according to the present invention. Firstly, a memory area is set in the control chip to pre-store a temperature standard, and then the temperature sensing element 10 is placed in the constant-temperature environment. When the temperature sensing element 10 is thermal equilibrated with the constant-temperature environment, the temperature sensing resistor is oscillated until the temperature measured by the temperature sensing element is consistent with the predetermined standard so as to determine the first oscillation time T1. And then, the reference resistor Ref is provided, and the reference resistor Ref is oscillated according to the first oscillation time T1 to determine an updated temperature standard. Then, the updated temperature standard is stored to the control chip to replace the temperature standard pre-stored in the memory area.

As shown in FIG. 3, the adjusting procedures of the present invention can be performed by the adjusting system 20. The method of the present invention performs the step S1 firstly. In other words, the control chip defines a memory area to pre-store a temperature standard. The temperature standard is equal to the predetermined standard ±ΔT. And then, the temperature sensing element 10 is turned into an adjusting model to begin the step S2.

In the step S2, the temperature sensing element is placed in a thermostatic trough (not shown) having a constant temperature. Then, the step S3 is performed.

In the step S3, the temperature of the temperature sensing element 10 is determined whether the temperature sensing element 10 thermally equilibrates with the thermostatic trough. If the result is true, then the step S4 is performed; and if the result is false, the step S2 is performed again. It should be noted that the temperature of the thermostatic trough should be almost consistent with the predetermined temperature standard. Otherwise, the temperature sensing element 10 cannot be adjusted due to the excessively large temperature offset. Therefore, the step S31 is performed to determine whether an unusual situation of the environment occurs. For example, the measure temperature is less than 0.05° C. within a continuous period of 16 seconds, the measure temperature is greater than 36° C., the waiting time for thermal equilibration is longer than 9 minutes, . . . and so on. If the result is true, the step S9 is performed; otherwise, the step S2 is performed again.

In step S4, the temperature sensing resistor installed in the temperature sensing element 10 is oscillated until the measured temperature is consistent with the predetermined standard so as to determine the first oscillation time T1. The first oscillation time T1 will be stored, and then the step S5 is performed. In the step S5, the reference resistor is oscillated according to the first oscillation time T1 to determine an updated temperature standard, which is equal to the predetermined standard ±ΔT, and then the updated temperature standard is stored to the memory area. Then, the step S6 is performed.

In the step S6, the adjusting system 20 performs an error detection procedure. An adjusting range of an temperature offset ΔT1 is set to determine whether the adjustment range of the updated temperature standard exceeds predetermined upper and lower bounds. If the result is true, the step S61 is performed; otherwise, performing the step S7.

In the step S61, when the adjustment range of the updated temperature standard exceeds the predetermined upper and lower bounds, the display unit 25 displays an error message.

In the step S7, the updated temperature standard, which is equal to the predetermined standard ±ΔT1, is read. The reference resistor Ref is oscillated until a temperature measured by the temperature sensing element 10 is consistent with the updated temperature standard so as to determine a second oscillation time T2. Then, the step S8 is performed.

In step S8, the temperature sensing resistor Rs is oscillated according to the second oscillation time T2, and then a measured temperature after calculating and converting is displayed. Then, the step S9 is performed.

In step S9, the adjusting system terminates the adjusting procedure. Accordingly, the present invention finely turns an updated temperature standard according to a temperature offset of the temperature sensing resistor of the temperature sensing element. Firstly, a temperature standard is pre-stored in a memory area of a memory unit (a control chip), and then a predetermined standard is defined and the temperature standard is set to be equal to the predetermined standard ±ΔT. The temperature sensing element is placed in a constant-temperature environment. After the temperature sensing element is thermal equilibrated with the constant-temperature environment, the temperature sensing resistor is oscillated until a temperature measured by the temperature sensing element is consistent with the predetermined standard so as to determine a first oscillation time. A reference resistor is provided, and the reference resistor is oscillated according to the first oscillation time to determine an updated temperature standard. And then, the updated temperature standard is stored to the memory unit (control chip) to replace the pre-stored temperature standard. Because the resistance variation of each temperature sensing resistor is different, the corresponding measured temperature standard for each temperature sensing resistor is different. Therefore, it is unnecessary for the system manufacturer to connect any compensation resistor in parallel or in series with the reference resistor. Therefore, the purpose to automatically adjust the temperature sensing element could be achieved, and the labor power and cost of time could be reduced.

Accordingly, the temperature sensing device proposed in the present invention is capable of monitoring body temperature changes and improving the accuracy of measurement in that the body temperature of the test subject can be directly measured. Moreover, various economically-efficient modes, such as single-to-single, single-to-multiple, and multiple-to-multiple real-time temperature monitoring modes, can be performed to obtain an accurate record of the body temperature change of the test subjects.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A method for adjusting a temperature sensing element, the temperature sensing element being coupled to a control chip and having a temperature sensing resistor, the method comprising following steps:
(1) setting a memory area of the control chip, wherein the memory area pre-stores a temperature standard, and then defining a predetermined standard and setting the temperature standard to be equal to the predetermined standard ±ΔT;
(2) providing an constant-temperature environment, and then placing the temperature sensing element in the constant-temperature environment and thermal equilibrating the temperature sensing element with the constant-temperature environment;
(3) oscillating the temperature sensing resistor until a temperature measured by the temperature sensing element is consistent with the predetermined standard so as to determine a first oscillation time; and
(4) providing a reference resistor, and oscillating the reference resistor according to the first oscillation time to determine an updated temperature standard, and then storing the updated temperature standard to the memory area to replace the temperature standard pre-stored in the memory area.

2. The method of claim 1, wherein the constant-temperature environment is a thermostatic trough.

3. The method of claim 1, wherein ΔT is a temperature offset corresponded to a resistance variation within an oscillation time T.

4. The method of claim 1 further comprising following steps:
(5) commanding the control chip to read the updated temperature standard, and then oscillating the reference resistor until a temperature measured by the temperature sensing element is consistent with the updated temperature standard so as to determine a second oscillation time; and
(6) oscillating the temperature sensing resistor according to the second oscillation time, and then displaying a measured temperature after calculating and converting.

5. The method of claim 1, wherein step (1) further comprises terminating adjusting the temperature sensing element when an unusual situation of the constant-temperature environment occurs.

6. The method of claim 1, wherein step (4) further comprises displaying an error message when an adjustment range of the updated temperature standard exceeds predetermined upper and lower bounds.

7. An adjusting system for adjusting a temperature sensing element, the temperature sensing element having a temperature sensing resistor and being coupled to a control chip and placed in a constant-temperature environment, the adjusting system at least comprising:
a memory unit for setting a memory area, wherein the memory area pre-stores a temperature standard and defines a predetermined standard, the temperature standard is set to be equal to the predetermined standard ±ΔT;
a signal generating unit for providing a reference resistor and respectively generating oscillation signals of the reference resistor and the temperature sensing resistor;
a nonlinear conversion circuit electrically connected to the signal generating unit and used for converting the oscillation signals to pulse signals;
a counting unit electrically connected to the nonlinear conversion circuit and used for determining a counting number of pulses according to the pulse signals and determining an oscillation time according to the counting number of pulses; and
a control unit electrically connected to the signal generating unit, the counting unit and the memory unit, the control unit being used for oscillating the temperature sensing resistor until a temperature measured by the temperature sensing element is consistent with the predetermined standard such that the counting unit determines a first oscillation time, and the control unit being used for oscillating the reference resistor according to the first oscillation time to determine an updated temperature standard and for storing the updated temperature standard to the memory area to replace the temperature standard pre-stored in the memory area.

8. The adjusting system of claim 7, wherein the constant-temperature environment is a thermostatic trough.

9. The adjusting system of claim 7, wherein ΔT is a temperature offset corresponded to a resistance variation within an oscillation time T.

10. The adjusting system of claim 7, wherein the control unit is electrically connected to the control chip.

11. The adjusting system of claim 7, wherein the control unit is integrated in the control chip.

12. The adjusting system of claim 7 further comprising a display unit electrically connected to the counting unit, the display unit is used for correspondingly displaying a measured temperature value of the temperature sensing resistor according to the counting number of pulses.
